(19) United States
(12) Patent Application Publication
(10) Pub. No.: US 2005/0051213 A1
(43) Pub. Date: Mar. 10, 2005

(54) Water- and vibration-sensing protection apparatus

(76) Inventor: William J. Clemens, Livonia, MI (US)

Correspondence Address: John G. Posa;Gifford, Krass, Groh, Sprinkle,, Anderson & Citkowski, P.C., 280 N. Old Woodward Ave., Suite 400, Birmingham, MI, 48009-5394, US

(21) Appl. No.: 10/657,795

(22) Filed: Sep. 5, 2003

(51) Int. Cl. G05D 9/12

(52) U.S. Cl. 137/392

(57) ABSTRACT

A water-sensing protection device for use with home appliances such as washing machines and dishwashers, incorporating a water-sensing probe that detects high water levels in a sink basin, wall discharge receiver or a stand pipe. The protection device also has a sensor that can be placed on the floor to detect the presence of water from the failure of the above-described appliances or the drainage system of the sink basin or the sink basin itself. The signal from the sensing probes may be used to deactivate the power to the appliance, resulting in the activation of an auditable alarm and warning light that a water overflow condition exists due to an obstruction in the drainage system, or the failure of the appliance or drainage system has occurred. An optional vibration sensor is also disclosed, since excessive vibration due to load imbalance could be indicative of a potential water problem.

### FIELD OF THE INVENTION

This invention relates generally to water-sensing protection devices and, in particular, to a device operative to deactivate the electric service to a water-utilization device prior to an overflow condition.

### BACKGROUND OF THE INVENTION

Most modern washing machines automatically cycle through various operations until the clothes are completely washed, rinsed, and partially dried. The drain hose (tube) of the washing machine through which the dirty water is discharged is usually inserted into a sink basin, wall discharge receiver or standpipe which, in turn, is coupled to the household drainage system.

Problems have arisen, however, in the use of such automatic washing machines when the household drainage system becomes clogged for any reason. When this occurs, large amounts of water will be pumped out of the machine onto the floor and cause considerable water damage.

Various washing machine overflow control units and devices have been proposed which purport to allow a person to employ the automatic washing machine and to leave same unattended without fear of drain overflow problems. However, these objectives are generally achieved by deactivating the supply to the washing machine through a mechanical float type sensing device, complex controls or requiring alteration to the appliance itself. As such, a skilled tradesperson is required to perform such alterations.

Some of such devices to be used with washing machines are show in U.S. Pat. Nos. 4,418,712, 3,185,789, 3,862,433, 4,069,837, 4,814,752, 5,026,954, 5,125,247. In U.S. Pat. Nos. 4,418,712 and 3,874,403, a combination of float-type sensor, fluid sensing switch and a conductive type sensor is used to monitor the presence of water in a stand pipe and on the floor. In U.S. Pat. No. 5,493,877, a water-sensing device was developed to monitor an overflow of water during the rinse cycle of a washing machine.

However, none of these devices may be used to monitor both washing machines and portable dishwashers, nor do they allow a combination of conductive water-sensing devices to be placed in a drain tub, wall discharge receiver, stand pipe and/or on the floor. Such devices are also generally incapable of monitoring the presence of water from the failure of the appliance or the drain system of the sink basin or the sink basin itself.

Accordingly, a need has long been recognized for a water-sensing protection device which can readily be incorporated into existing houses and which is reliable and simple in construction that can be used with washing machines and portable dishwashers. Further, the need has been felt for an improved water-sensing protection device which could readily detect an approaching high water level or the presence of water on the floor due the failure of the appliance or the drainage system of the sink basin or the sink basin itself deactivates the appliances without fear of overflow and extensive water damage.

### SUMMARY OF THE INVENTION

The present invention resides in an improved water-sensing prevention device that can readily be positioned within a sink basin, wall discharge receiver or standpipe of the drainage system without modification to the same or requiring skilled trades.

The preferred embodiment, which may be used with a washing machine, portable or installed dishwasher, or any water utilization device having a drain and electrical plug, uses a plurality of encased sensors that can be placed on the floor or other appropriate location to detect water level(s). Enclosed switching apparatus is further provided which is operatively connected to the sensor(s) such that upon contact with water, the electrical circuit to the water utilization device is interrupted, thereby preventing overflow or further damage.

In terms of apparatus, the system includes at least a pair of water sensors, each operative to control an electrical circuit in the presence of water, a plug for making contact to an electrical outlet, an outlet for receiving the plug of the water-utilization device, and an enclosure containing electrical circuitry. The circuitry includes an electrically operated switch in an electrical path between the outlet for receiving the plug of the water-utilization device and the plug for making contact to the electrical outlet, as well as electrical components interfaced to the water sensors which collectively cause the electrically operated switch to open the electrical path in the event that either water sensor detects the presence of water.

In the preferred embodiment, one of the water sensors is contained in a flattened housing for detecting the presence of water on a floor. An optional vibration sensor is also disclosed, since excessive vibration due to load imbalance could be indicative of a potential water problem.

### BRIEF DESCRIPTION OF THE DRAWINGS

A more complete understanding of the invention may be had by reference to the following detail description when taking in conjunction with the accompanying drawings wherein:

FIG. 1 is a perspective illustration of a typical installation utilizing a preferred embodiment according to the invention;

FIG. 2 is an illustration of an alternative overflow protection application, namely, a water discharge wall outlet box;

FIG. 3 is an illustration of a further alternative overflow protection application, in this case a water discharge standpipe;

FIG. 4 is a perspective illustration of an enclosure adapted to be mounted in a wall outlet with both the water-sensing probe and the floor water sensor;

FIG. 5 is different perspective illustration of an enclosure adapted to be mounted in a wall outlet with both the water-sensing probe and the floor water sensor;

FIG. 6 is a detailed illustration of a water-sensing probe according to the invention;

FIG. 7 is a detailed illustration of a floor water sensor according to the invention;

FIG. 8A is a wiring diagram of a water-sensing protection device system according to the invention using a separate plug and socket;

FIG. 8B is a wiring diagram of an alternative embodiment using a piggy-back plug and socket arrangement;

FIG. 9 is a perspective view of a wall-mountable enclosure utilizing a piggyback electrical connection, dual water probes, and vibration sensor; and

FIG. 10 is a drawing of a vibration sensor according to the invention.

### DETAILED DESCRIPTION OF THE PREFERRED EMBODIMENTS

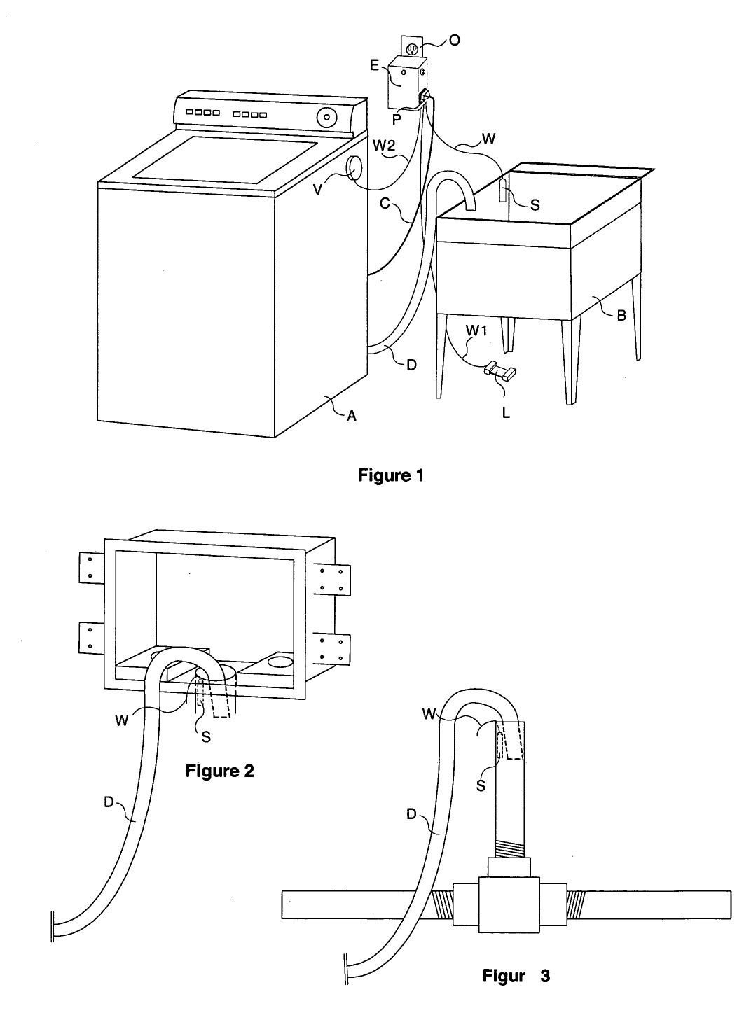

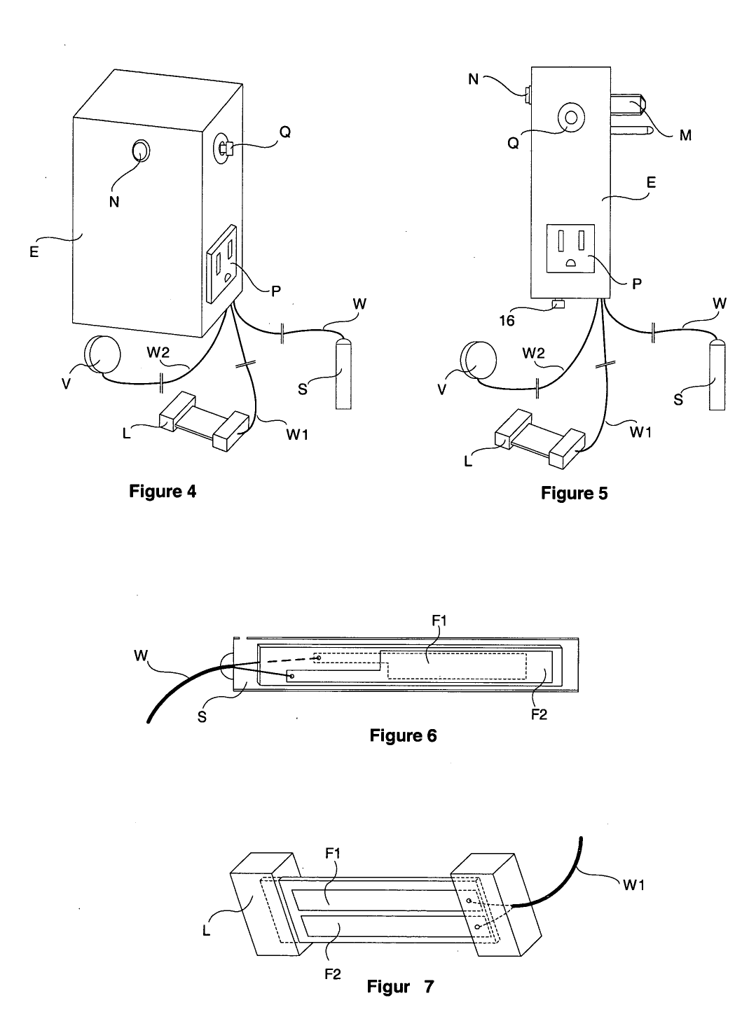

Referring now to drawings, FIG. 1 shows an appliance A typically including a power cord C adapted for connection into any conventional wall outlet O and a drain hose D through which waste liquid is discharged into sink basin B, wall discharge receiver (FIG. 2) or standpipe (FIG. 3) into a conventional trap connected to the sewer line.

The “appliance” as used herein may take the form of an automatic clothes washer, installed or installed/portable dishwasher, or any other electrically operated water-utilization apparatus that discharges water following use and plugs into an electrical outlet.

Referring to FIG. 1 and other relevant drawings, the invention is preferably housed in an enclosure E to which the appliance A and probes and sensors are interconnected. The signals generated by the water-sensing probes S and L and vibration sensor V are brought to enclosure E by means of insulated two-conductor wiring W, W1 and W2, respectively. Enclosure E includes an electric plug receptacle outlet P for receiving the male portion of the electric cord C of the appliance. Enclosure E is provided with a male connector M that may be inserted into any electrical wall outlet, show herein as electrical wall outlet receptacle O.

In addition to the foregoing plug receptacle outlet P, a reset switch Q, test switch 16, audio alarm 22 and warning light N are preferably included in the enclosure E. In this form, the power delivered through the electric cord C to the appliance A may be controlled by water contacting the water probes S, L and the vibration sensor V.

FIGS. 6 and 7 show water-sensing probes according to the invention, both of which being operative to produce a switching signal indicative of the presence of water at a predetermined level. The probe of FIG. 6 includes a cylindrical housing sealed at the top with a breather hole on the side and the other end of the tube open and to be inserted into said sink basin, wall discharge receiver or stand pipe, said probe to produce said switching signal upon partial immersion of said water-sensing probe in water. The probe of FIG. 7 has a sensor that can be placed on the floor to detect the presence of water from the failure of the above described appliances or drainage system of the sink basin or main drainage stack pipe, said sensor to produce said switching signal upon contact with water.

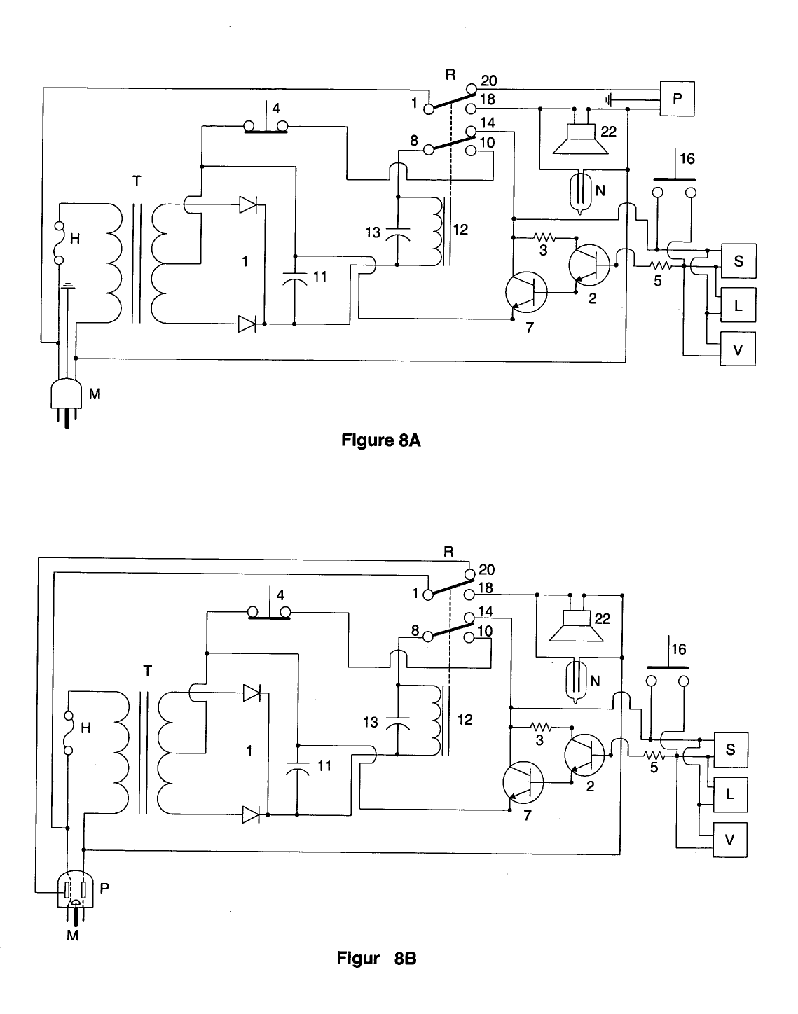

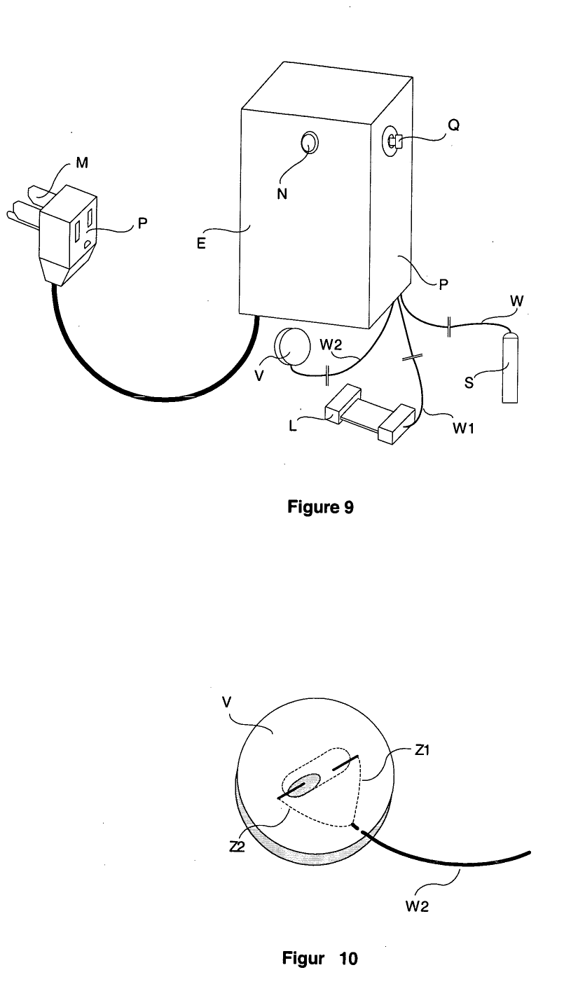

FIGS. 8A and 8B are schematic diagrams that show important electrical components and alternative plug and socket arrangements. FIG. 8A is a wiring diagram of a water-sensing protection device system according to the invention using a separate plug and socket, whereas FIG. 8B is a wiring diagram of an alternative embodiment using a piggy-back plug and socket arrangement shown in FIG. 9, for example (M, P). In each case, however, receptacle outlet P is tied in series with a relay switch assembly R pulled open by a relay coil 12. The input to the switch assembly R may originate at the wall outlet.

FIG. 10 is a diagram of a vibration sensor according to the invention. The sensor, V, includes a body with a cavity to which two wires Z1, Z2, interface to the enclosure E through cable W2. The cavity into which the electrodes protrude, includes a slug of mercury that is able to move back and forth between the electrodes and, in the event that the sensor V experiences excessive vibration, the slug will at least at one point short the electrodes out, causing the unit to detect a potential problem. The body of the sensor V, preferably includes some sort of tape or magnetic feature (not shown) allowing it to be placed onto an appliance such as a washing machine, dishwasher, and so forth, and oriented in rotational fashion until detection liability assumes a desired level.

Referring to FIG. 8A in particular, relay coil 12 is connected in series between the positive terminals of the rectifiers 1 across relay R contacts 8 and 14, to element F1 of the water-sensing probes S and L, and wire Z1 of the vibration sensor V to one side of the test switch 16 to the collector of transistor 2 through resistor 3 and to the collector of transistor 7. Capacitor 13 is connected in parallel with coil 12. Element F2 of the water-sensing probes S and L, and wire Z2 of the vibration sensor V are connected to one side of the test switch 16 and to the base of transistor 2 through resistor 5. The emitter of transistor 2 is connected to the base of transistor 7, forming a Darlington configuration.

The emitter of transistor 7 is connected to the negative terminal on the secondary side of transformer T. Capacitor 11 is connected across the positive and negative terminals on the secondary side of transformer T. The receptacle outlet P is connected from one side of the electrical source plug M then through the foregoing relay contacts 1 and 20 back to the other side of the electrical source plug M. One wire of the warning light N and auditable alarm 22 are connected to pin 18 of relay R and the other wires are connected to other side of the electrical source plug M. One wire of reset switch 4 is connected to pin 10 of relay switch assembly R. The other wire of reset switch 4 is connected to the negative side of the secondary side of transformer T, capacitor 11 and to the emitter of transistor 7. One wire of the primary side of transformer T is connected to electric source plug M and the other side of transformer T is connected to the other side of electric source plug M through fuse H. The ground wire of electric source plug M is connected to the ground wire of the plug receptacle outlet P.

### Operation

The operational function of the hereinbefore described is as follows. Under normal operating conditions, contacts 1 and 20 of relay R are closed allowing the washing machine, portable dishwasher, or other water-utilization device to function in a conventional manner. Also, contacts 8 and 14 are closed and will provide a path to operationalize the water-sensing probes S and L. However, when water comes in contact with water-sensing probes S or L, or excessive vibration excites vibration sensor V, relay coil 12 is energized which interrupts the electrical supply to the appliance, opening relay R contacts 1 and 20, and relay R contacts 8 and 14. In this energized state, coil 12 is energized, relay R contacts 8 and 10 are connected to provide a path for the relay coil 12 to be continually energized by transformer T until the reset switch 4 is actuated. Simultaneously, relay R contacts 1 and 18 are connected to provide a path for the audible alarm 22 and warning light N to be energized from the electrical supply plug M. In this state, the appliance will stay deactivated and the auditable alarm 22 and warning light N will stay energized. When reset switch 4 is activated, the path that continually energizes relay coil 12 is interrupted, thus, deactivating the audible alarm 22 and warning light N and returning the appliance back to normal operating condition.

1.-3. (cancelled)

4. The water-sensing and protection apparatus of claim 13, wherein the vibration sensor includes two electrodes extending into a sealed cavity containing a slug of mercury or other electrically conductive liquid.

5. The water-sensing and protection apparatus of claim 13, wherein the vibration sensor includes a body having an adhesive or magnetic material enabling it to be attached to and oriented on an appliance.

6.-11. (Cancelled)

12. The water-sensing and protection apparatus of claim 13, wherein the electrical components interfacing the sensors to the second set of contacts includes a pair of transistors arranged in a Darlington configuration.

13. Water-sensing and protection apparatus configured for use with a water-utilization device such as a washing machine, dishwasher or other appliance having a first plug for making connection to a first electrical outlet, the apparatus comprising:
a plurality of water sensors and at least one vibration sensor;
a second plug for making connection to the first electrical outlet;
a second outlet for receiving the first plug of the water-utilization device; and
an enclosure containing electrical circuitry, including:
a relay having a first set of contacts controlling the electrical path between the second plug and the second outlet, and a second set of contacts controlling the first set of contacts; and
electrical components interfacing the sensors to the second set of contacts, such that if any sensor is electrically activated the relay trips causing the second set of contacts to open the electrical path between the second plug and the second outlet.

14. The water-sensing and protection apparatus of claim 13, wherein one of the water sensors is contained in a flattened housing for detecting the presence of water on a floor.

15. (Cancelled)

16. The water-sensing and protection apparatus of claim 13, wherein the second plug and the second outlet are aligned on the same plug-in body.

17. The water-sensing and protection apparatus of claim 13, further including a self-test switch mounted on the enclosure, the activation of which causes the electrically operated switch to open the electrical path between the second plug and the second outlet.

18. The water-sensing and protection apparatus of claim 13, further including a warning light mounted on the enclosure which illuminates when the electrical path between the second plug and the second outlet has been opened.

19. The water-sensing and protection apparatus of claim 13, further including an audible alarm mounted on the enclosure which sounds when the electrical path between the second plug and the second outlet has been opened.

20. The water-sensing and protection apparatus of claim 13, further including a reset switch mounted on the enclosure, the activation of which causes the electrical path between the second plug and the second outlet to be re-established if previously opened.
